(19) United States
(12) Patent Application Publication
(10) Pub. No.: US 2025/0057351 A1
(43) Pub. Date: Feb. 20, 2025

(54) APPARATUS FOR COLD-BREWED COFFEE AND OTHER BEVERAGES USING PEF

(71) Applicants: Mark L. PETERSON, Plymouth, MN (US); Thomas Kevin MEHRKENS, Bellevue, WA (US)

(72) Inventors: Mark L. PETERSON, Plymouth, MN (US); Thomas Kevin Mehrkens, Bellevue, WA (US)

(21) Appl. No.: 18/803,031

(22) Filed: Aug. 13, 2024

Related U.S. Application Data
(60) Provisional application No. 63/519,637, filed on Aug. 15, 2023.

(51) Int. Cl. A47J 31/00; A23F 5/26; A47J 31/18; A47J 31/44; A47J 31/46

(52) U.S. Cl. CPC A47J 31/002; A23F 5/26; A47J 31/18; A47J 31/4403; A47J 31/468

(57) ABSTRACT

Cold brewing systems for beverages such as coffee, espresso, tea, or infused water and methods of using the systems. The systems use two or more electrodes to create a Pulse Electrical Field (PEF) used to solubilize and extract numerous organic compounds from coffee grounds, tea, or other flavored substances. The PEF brewing system may be a flow-through, a drip, or a pot brew system.

### CROSS-REFERENCE

This application claims priority to U.S. provisional application No. 63/519,637 filed Aug. 15, 2023 and titled APPARATUS FOR BREWING COLD-BREWED COFFEE AND OTHER BEVERAGES USING PEF, the entire disclosure of which is incorporated herein by reference for all purposes.

### FIELD OF INVENTION

The present disclosure relates to apparatuses for manufacturing beverages such as cold brew coffee, espresso, tea, or infused water.

### BACKGROUND

Domestic coffee consumption in the United States is estimated at 146 billion cups per year with a market size of over $80 billion dollars. Most coffee consumed is prepared through various hot brewing methods, where the hot water solubilizes and extracts numerous organic compounds from the roasted coffee grounds. Because the “hot” of hot water brewing also solubilizes unwanted compounds that negatively affect the taste, cold brewing coffee preparation techniques have grown in popularity, both at-home and in consumer (or ready to drink) markets.

Simply put, cold brew tastes better. It is expected that the cold brew coffee market will experience more than a 26% annual growth between 2022 and 2027.

For cold brew lovers, the options are to buy expensive, premade products or plan their morning brew well ahead of time. Unlike hot coffee, cold brew takes 8 to 24 hours to steep. There are efforts to speed up the cold brewing process including using ultrasonic and pulsed laser techniques, but there are problems with these. The ultrasonic and laser equipment is too expensive and bulky for widespread commercial or home use. Additionally, while the laser-based apparatus could match the brew time of drip coffee machines, there are inherent laser safety issues.

### SUMMARY OF THE INVENTION

The beverage-making apparatus described herein, and methods of using it, satisfy the needs listed above and provide additional improvements and advantages. The present disclosure provides various embodiments utilizing Pulse Electrical Field (PEF) to improve the extraction process for beverages such as coffee (e.g., drip coffee, percolated coffee, cold brew, espresso), tea and other beverages that have a flavor extracted from a solid or semi-solid substances. Pulse Electrical Field (PEF) uses electrical pulses to create both non-thermal reversible and irreversible electroporation (i.e., creation of pores) in the beverage-forming substance.

PEF has been used in juice pasteurization, for improving the quality of processed potato products, and in medical products to necrosis cancerous tissue and improve cardiac electrical pathways. PEF has also been used in processes for decaffeinating green or roasted coffee beans.

In cold brewing, the desired bioactive compounds come from the surface and near surface volumes of the ground coffee. PEF creates additional pores in the coffee, thus enhancing solubilization of the bioactive compounds in ground coffee, providing faster solubilization of the coffee essence into the water. PEF cold brew systems, such as describe herein, have brew times similar to that of a traditional hot brew system, but without the bulk, costs, and safety concerns of ultrasonic or laser-based systems.

This disclosure provides, in one particular embodiment, a PEF brewing system having a chamber for receiving a mixture of a liquid and a substance for extraction of flavor therefrom, a liquid source fluidly connected to the chamber to provide the liquid to the chamber, a pulse source comprising at least two electrodes, the pulse source in fluid and electrical contact with the mixture in the chamber to provide a field strength of at least 0.2 KV/cm to the mixture, a liquid pump fluidly connected to the chamber, and a container fluidly connected to the pulse source to receive the liquid from the pulse source.

This disclosure also provides, in another particular embodiment, a method of cold brewing a beverage, the method including providing a chamber retaining a substance for extraction of flavor therefrom, adding a liquid to the substance in the chamber to form a mixture, exposing the mixture in the chamber to a pulsed electric field at a field strength of at least 0.2 KV/cm, filtering the exposed mixture to extract brewed liquid, and collecting the brewed liquid in a container.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following Detailed Description.

### BRIEF DESCRIPTION OF THE DRAWINGS

The disclosure may be more completely understood in consideration of the following detailed description of various embodiments of the disclosure in connection with the accompanying drawing.

FIG. 1 is a perspective view of a first embodiment of a PEF coffee maker, particularly, a pot brew PEF coffee maker.

FIG. 2 is a perspective view of a glass container from the coffee maker of FIG. 1.

FIG. 3 is a schematic block diagram for the coffee maker of FIG. 1.

FIGS. 4A through 4D are views of different designs of an electrode chamber, e.g., for the coffee maker of FIG. 1, where: FIG. 4A is a perspective view of a large parallel electrode chamber; FIG. 4B is a perspective view of a small parallel electrode chamber; FIG. 4C is a cross-section view of the small parallel electrode chamber of FIG. 4B; and FIG. 4D is a cross-section view of a small co-linear electrode chamber.

FIG. 5 is a perspective view of a second embodiment of a PEF coffee maker, particularly, a drip brew PEF coffee maker.

FIG. 6 is a schematic block diagram for the coffee maker of FIG. 5.

FIGS. 7A and 7B illustrate an electrode chamber, e.g., for the coffee marker of FIG. 5, where: FIG. 7A is a perspective view of a multi electrode chamber; and FIG. 7B is a cross-section view of the multi electrode chamber.

FIG. 8 is a perspective view of a third embodiment of a PEF coffee maker, particularly, a flow-through brew PEF coffee maker.

FIG. 9 is a schematic block diagram for the coffee maker of FIG. 8.

FIG. 10 is a cross-section view of a portion of the flow-through PEF coffee maker of FIG. 8.

FIGS. 11A and 11B are graphical representations of typical PEF pulse cycles, particularly, FIG. 11A is a square waveform and FIG. 11B is an exponential decay waveform.

FIGS. 12A and 12B are graphical representations of solution conductivity for a coffee having a water ratio of 1:42 (by wt.).

FIGS. 13A and 13B are graphical representations of solution conductivity for a coffee having a water ratio of 1:32 (by wt.).

FIG. 14 is a photograph of a chart used to quantify sample clarity.

### DETAILED DESCRIPTION

The following description describes various embodiments of beverage-making systems having a Pulse Electrical Field (PEF) generator that provides electrical pulses to the beverage-creating substance (e.g., coffee grounds, tea leaves, etc.) to create pores in the substrate by way of non-thermal reversible and/or irreversible electroporation.

The PEF system includes a PEF generator unit (and appropriate controller) and a pulse source, which includes at least two electrodes. The pulse source is configured to have coffee grounds or other substance from which a flavor is to be extracted in close proximity to the electrodes. The pulse source can include a chamber for retaining the coffee grounds or other substance in close proximity to the electrodes.

The pulses create an electrical voltage potential across the individual coffee ground grains resulting in reversible and irreversible electroporation, depending on the field intensity. Both reversible and irreversible electroporation allow for a rapid non-thermal solubilization and extraction of the desired organic compounds into the circulating water.

The systems described herein are particularly conducive for “cold brewing,” where the beverage-creating substance is exposed to cold or room temperature liquid (e.g., water); the application of the electrical pulses increases the speed of cold brewing to that similar to a traditional hot brew system. Although the PEF systems are intended for cold brewing, any of the systems could be used in a hot brewing application.

The electric field associated with PEF is governed by the Laplace equation, the solution of which yields the electrical potential across the ground coffee. This electric field results in reversible or irreversible electroporation in the grounds depending on the actual field strength. Enhanced solubilization occurs with both reversible and irreversible electroporation. A field strength >800 V/cm is consistent with irreversible electroporation. PEF is non-thermal and has minimal effect on the extraction of unwanted organic compounds.

It is noted that although the following discussion is directed to coffee makers, the PEF technology described herein can be applied to making any beverage where flavor is extracted from a substance, such as tea and infused water.

Additionally, any water, such as tap, filtered, deionized, or distilled water can be used.

Described herein is a PEF (Pulse Electrical Field) system for cold brewing coffee, tea or infused water, the system having a source such as a chamber or container that retains unbrewed water; unbrewed coffee grounds, tea or other ingredients; brewed coffee, tea or infused water; and equipment for circulation of the liquid mixture. Present within the chamber or container are two or more electrodes that supply a pulsed electrical field electroporation treatment to the coffee grounds, tea or other ingredients mixture.

Also described herein is a PEF system for cold brewing coffee, espresso, tea or infused water, the system having a reservoir or external source for unbrewed water, a chamber or container for coffee grounds, tea or other ingredients, and a container for the brewed coffee, espresso, tea or infused water, where the containers have distinct volumes with fluid flow between. The chamber or container for the coffee grounds, tea or other ingredients contains two or more electrodes that supply a pulsed electrical field electroporation treatment to the coffee grounds, tea or other ingredients.

Still further described herein is a PEF flow-through system for cold brewing coffee, espresso, tea or infused water, the system having a chamber having an entrance for a mixture of water and coffee grounds, tea or other ingredients, a volume that contains two or more electrodes that supply a pulsed electrical field electroporation treatment to the coffee grounds, tea or other ingredients, and a chamber exit for the brewed coffee, tea or infused water.

In any of these systems described above and below and variations thereof, any of the reservoirs and containers may be a permanent part of the main frame or base of the system or may be removable therefrom. Any of the reservoirs and containers may be, e.g., glass, metal, or plastic.

There are at least two electrodes in every system, in some systems three electrodes and in other systems more than three electrodes. When only two electrodes are present, they have opposite polarity. Any additional electrodes over two may have either polarity. The polarity can be switchable, e.g., during the brewing cycle. The electrodes can have a cycle with a voltage “on” pulse and voltage “off” or negative pulse. Typically, the “on” pulse is shorter than the “off” pulse; examples of “on” pulse lengths are 10 microseconds to 50 microseconds. A typical on/off cycle can be, e.g., 50 to 100 microseconds to, e.g., 1 to 5 seconds.

The electrodes expose the coffee grounds, tea, or other substance and the liquid mixture to a field strength of at least 0.2 KV/cm. In some embodiments the field strength is between 0.2 KV/cm and 5.0 KV/cm, and in other embodiments between 0.8 KV/cm and 3.0 KV/cm. The electrodes also expose the substance and the liquid to an energy of at least 5 J/ml. In some embodiments the energy exposure is between 5 J/ml to 50 J/ml, and in other embodiments between 10 J/ml to 24 J/ml. The electrodes can have the same or different field strengths.

The electrodes may be arranged sequentially (so that liquid flows sequentially through or past the multiple electrodes) or the electrodes may be arranged on various (e.g., opposite) sides of the liquid. The electrodes are any suitable size and shape and can be flat, curved, or cylindrical in shape.

The PEF voltage, output, and/or pulse length can be automatically adjusted based on the resistivity or conductivity of the unbrewed water being used.

Any of the systems can include various safety switches or circuits to prevent operation if an unsafe condition exists.

Each of the PEF coffee maker systems described herein includes a source of a pulsed electric field (PEF); the pulse source applies intermittent pulses of energy to a mixture of liquid (e.g., water) and the substance (e.g., coffee grounds) from which flavor is to be extracted.

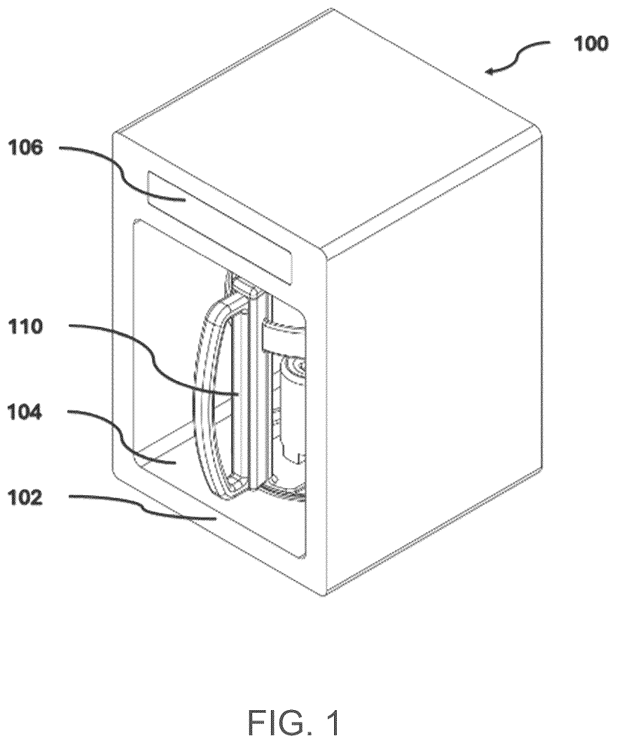

Turning to FIGS. 1 through 3, a first embodiment of a PEF coffee maker is shown, particularly, a pot brew PEF coffee maker 100. In this embodiment, the coffee grounds, unbrewed water, brewing chamber (which includes the pulse source), and the brewed coffee are in the same volume with internal circulation to inhibit the non-soluble coffee grounds from settling out of the mixture. In this embodiment, the PEF generator unit and appropriate controller are separate from the pulse source, however, all of the chamber, the liquid source, the pulse source, the liquid pump and the container are present as a single unit.

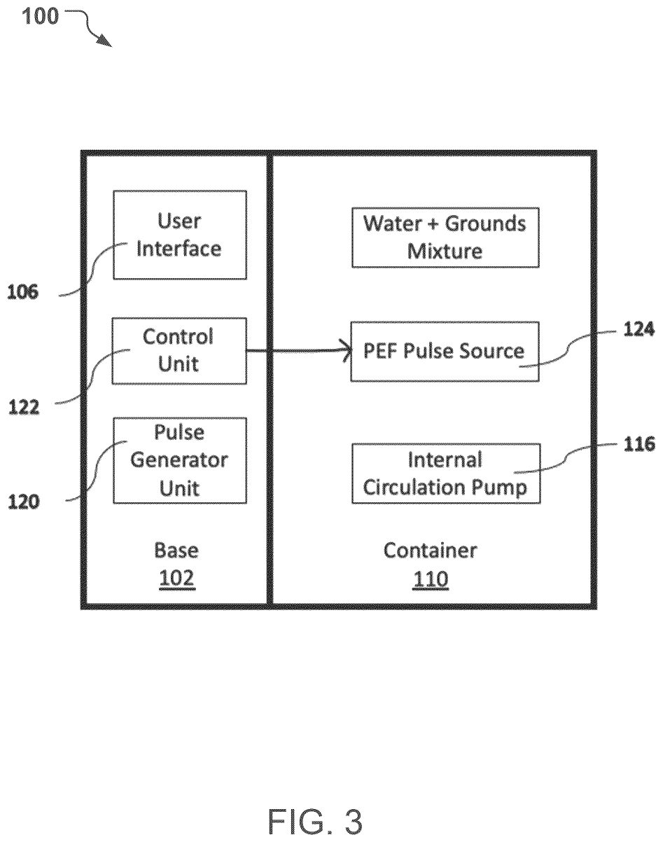

The pot brew PEF coffee maker 100 includes a base 102 with a pot cubby 104 having a container 110 received therein. The container 110 is removeable and replaceable into the pot cubby 104, and can be a glass container 110. Internal to the base 102 are various system components including a user interface 106, and a PEF pulse generator unit 120 and a control unit 122 therefor (see FIG. 3).

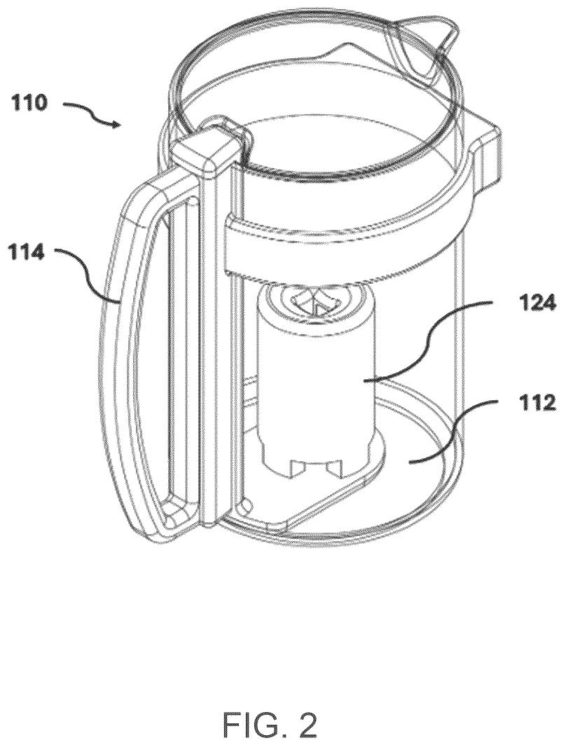

Seen in FIG. 2 removed from the pot cubby 104, the container 110 includes a water reservoir volume 112, a handle assembly 114, and a pulse source 124. Not seen in FIG. 2 but in FIG. 3, also within the container 110 is an internal circulation pump 116. When the container 110 is seated within the pot cubby 104, as in FIG. 1, the pulse source 124 is operably (e.g., electrically) connected to the pulse generator unit 120 through the control unit 122. The pulse source 124 is also operably (e.g., fluidly) in contact with the container 110, in this particular embodiment, the pulse source 124 is present within the container 110.

The pulse from the pulse source 124 creates an electrical voltage potential across the individual coffee ground grains circulating within the pulse source 124 which is within the container 110, resulting in reversible and irreversible electroporation, depending on the field intensity. Both reversible and irreversible electroporation allow for a rapid non-thermal solubilization and extraction of the desired organic compounds into the circulating water.

The PEF system (that being the PEF generator unit 120, its controller, and the pulse source 124) is configured to expose the liquid (e.g., water with coffee grounds suspended therein) during brewing to a field strength of at least 0.2 KV/cm. In some embodiments, the field strength is between 0.2 KV/cm and 5.0 KV/cm and in other embodiments between 0.8 KV/cm and 3.0 KV/cm.

The PEF generator is also configured to expose the liquid to an energy of at least 5 J/ml. In some embodiments, this energy exposure is between 5 J/ml to 50 J/ml, and in other embodiments between 10 J/ml to 24 J/ml.

In operation, water (not shown) is added to the glass container 110 of the PEF coffee maker 100. As indicated above, the water may be any water. For most applications, the conductivity of filtered and distilled water is typically too low for efficient PEF, but liquid circulation (as with this embodiment) allows the rapid solubilization of compounds to increase the water conductivity. Coffee grounds (not shown) are added to the glass container 110.

The user places the glass container 110 in the pot cubby 104 and presses the start button (not shown), but which is typically part of the user interface 106. Other controls that may be part of the user interface 106 include a stop button, a brew strength adjustment (e.g., light, medium, dark), and a delay-start timer. A brew controller (not seen) verifies any number of safety features (e.g., is the container 110 correctly position within the pot cubby 104, does the container 110 contain adequate level of liquid, etc.) before starting the brewing process which includes the PEF. After passing pre-start safety checks, the controller starts the internal circulation pump 116 and the pulse generator unit 120 and pulse source 124.

The PEF coffee maker 100 brews for at least 30 seconds, with the pulse generator unit 120 and pulse source 124 operating to apply a PEF to the coffee grounds suspended in the circulating water. In some embodiments, this brew time is between 30 secs and 720 secs (12 minutes) and in other embodiments between 180 secs (3 minutes) and 360 secs (6 minutes).

During the brew time, the pot brew controller may perform additional safety checks, which may include ground-fault circuit interrupter (GFCI) and/or electrical breakdown (arcing).

The GFCI would work like a home GFCI circuit by comparing the amount of current going to and returning from equipment along the circuit. Testing for breakdown may include the measurement of the pulses amplitude (amps), pulse duration (sec) and/or their trend over multiple cycles. An increase in amplitude and/or decrease of duration especially if trended over multiple pulses would be consistent with breakdown.

If a GFI or breakdown is indicated the process controller will stop the pulse generator, circulation and inform the user.

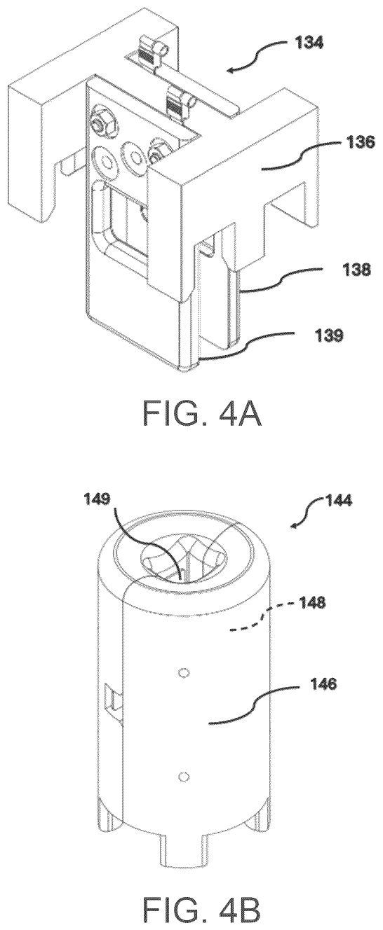

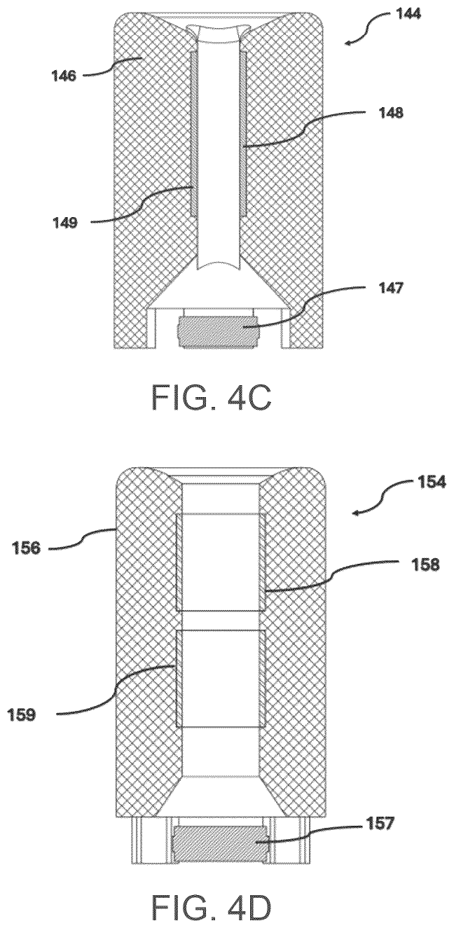

FIGS. 4A through 4D illustrate various alternate electrode configurations for use as the pulse source 124 of the PEF coffee maker 100 and variations thereof.

FIG. 4A shows a large parallel electrode pulse source 134. This design includes a support housing 136 and electrodes 138, 139. One of the electrodes 138, 139 is either ground/negative (−) or positive (+), and the other electrode 138, 139 is the other polarity.

FIG. 4B shows a small parallel electrode pulse source 144 with small electrodes suitable for larger conductivity mixtures. This design includes a housing 146 and flat electrodes 148, 149. FIG. 4C shows the small parallel electrode pulse source 144 of FIG. 4B in cross-section, showing the parallel flat electrodes 148, 149 and internal circulation pump 147.

FIG. 4D shows a small co-linear electrode pulse source 154. This version may include a housing 156 and cylindrical electrodes 158, 159 and internal circulation pump 157.

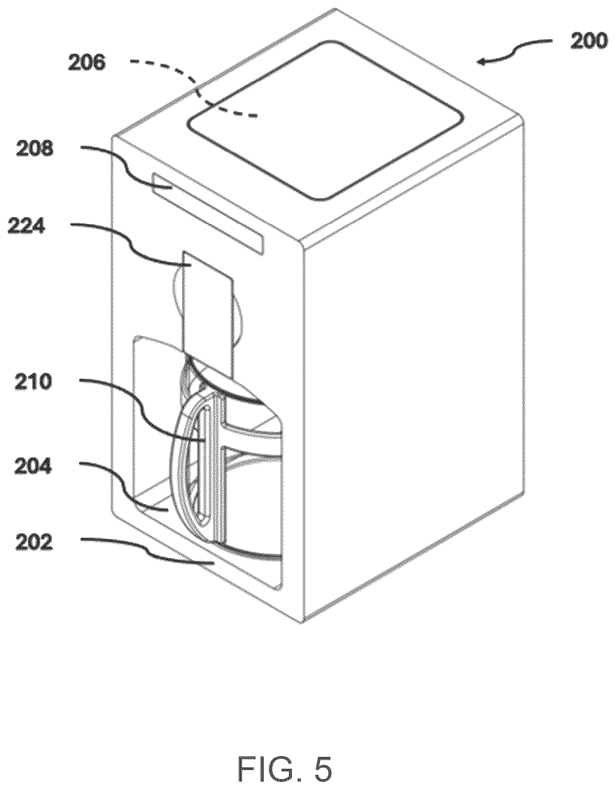

Turning to FIG. 5, a second embodiment of a PEF coffee maker is shown, particularly, a drip brew PEF coffee maker 200. The PEF coffee maker 200 includes a source of a pulsed electric field (PEF).

In this embodiment the unbrewed water, brewing chamber (which includes the pulse source) and brewed water all have distinct volumes with flow from one into another and eventual intermingling. The liquid flow between the distinct volumes may be due to gravity, mechanically pumped or pressure assisted. Additionally in this embodiment, the PEF generator unit and appropriate controller are separate from the pulse source.

The drip brew PEF coffee maker 200 includes a base 202 with a pot cubby 204, a user interface 208, a water supply 206, a pulse source 224, and a PEF pulse generation unit (not shown). Within the pot cubby 204 is a removable container 210, e.g., a glass container.

The water supply 206 may be a reservoir present within the base 202 to temporarily store water to be used in the brewing of the coffee. The water supply 206 is configured to dispense the stored water through a water dispensing port (not shown), e.g., at a lowest side of the water supply 206. In other embodiments, the water supply 206 is operably coupled to a water supply source (not shown), such as a faucet or plumbed line, so that an appropriate amount of water is automatically supplied, on-demand, from a water supply source (not illustrated) and the water is dispensed through the water dispensing port.

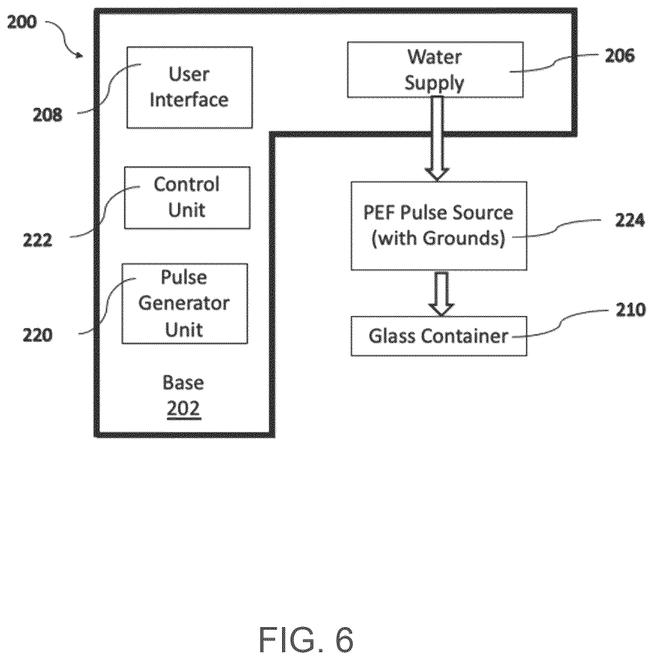

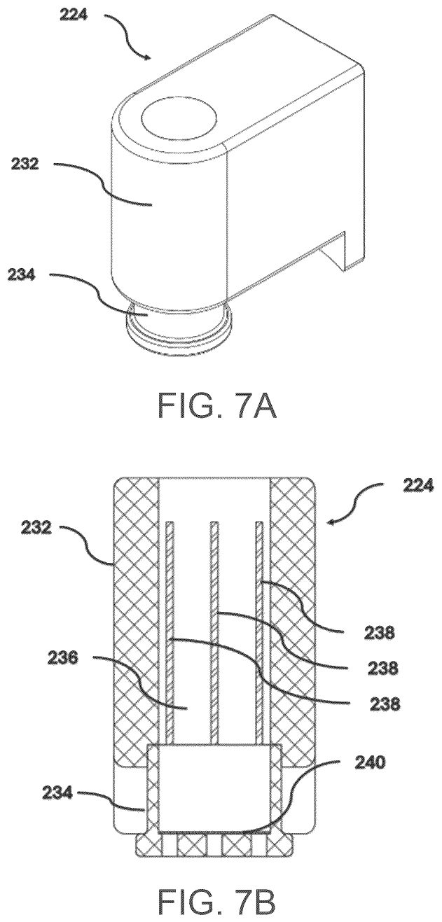

FIG. 6 provides a schematic overview of the PEF coffee maker 200 of FIG. 5. The base 202 includes various system components including a PEF generator unit 220 and its control unit 222, the user interface 208, and the water supply 206. The base 202 also includes a pulse source 224, which may be removable from the base 202; additional details of the pulse source 224 are shown in FIGS. 7A and 7B. The pulse source 224 is configured to have coffee grounds in close proximity to the electrodes. The pulse source 224 includes a chamber for retaining the coffee grounds in close proximity to the electrodes. Flow from the water supply 206 passes through the grounds in the multi electrode pulse source 224, through a filter 240 and into the glass container 210.

FIG. 7A shows a removable multi electrode pulse source 224 with a housing 232 and a filter holder 234. The housing 232 of the pulse source 224 is configured to retain coffee grounds therein, as a water:grounds mixture. In FIG. 7B, an interior of the multi electrode pulse source 224 is shown, including the housing 232, an internal volume 236 within the housing 232, a filter 240 in the filter holder 234, and shows multiple electrodes 238, specifically, three of five electrodes 238 in this embodiment. One of the electrodes 238 is either ground/negative (−) or positive (+), with the other electrodes 238 being the other polarity. Such a multiple electrode design (e.g., five electrodes) is conducive for high conductivity concentrated water:grounds mixtures.

The PEF system (that being the PEF generator unit 220 and the pulse source 224) is configured to expose the coffee grounds (retained in the pulse source 224) to a field strength of at least 0.2 KV/cm. In some embodiments, the field strength is between 0.2 KV/cm and 5.0 KV/cm and a particular example is between 0.8 KV/cm and 3.0 KV/cm.

The PEF generator is also configured to expose the coffee grounds to an energy of at least 5 J/ml. In some embodiments, this energy exposure is between 5 J/ml to 50 j/ml, and a particular example is between 10 J/ml to 24 j/ml.

In operation, water (not shown) is obtained from the water supply 206; the water supply 206 may be a reservoir holding a desired volume of water or the water supply 206 may be on-demand, directly piped. For this drip brew PEF coffee maker 200, any water such as tap, filtered or distilled water can be used. Coffee grounds (not shown) are added to the housing 232 of the pulse source 224 and it is inserted to the base 202. The user places the glass container 210 into the pot cubby 204 and presses a start button of the user interface 208.

The controller then verified safety features (e.g., the glass container 210 and the pulse source 224 are correctly positioned within the base 202, etc.) before starting PEF.

After passing pre-start safety checks the controller starts the circulation and pulse generator. As with the pot brew PEF coffee maker 100, the PEF pulse creates an electrical voltage potential across the individual grains resulting in reversible and irreversible electroporation depending on the field intensity, which allows for a rapid non-thermal solubilization and extraction of the desired organic compounds into the water.

During the brew time the controller may perform additional safety checks.

The parameters for brewing with the drip brew PEF coffee maker 200 can be the same as those for the pot brew PEF coffee maker 100.

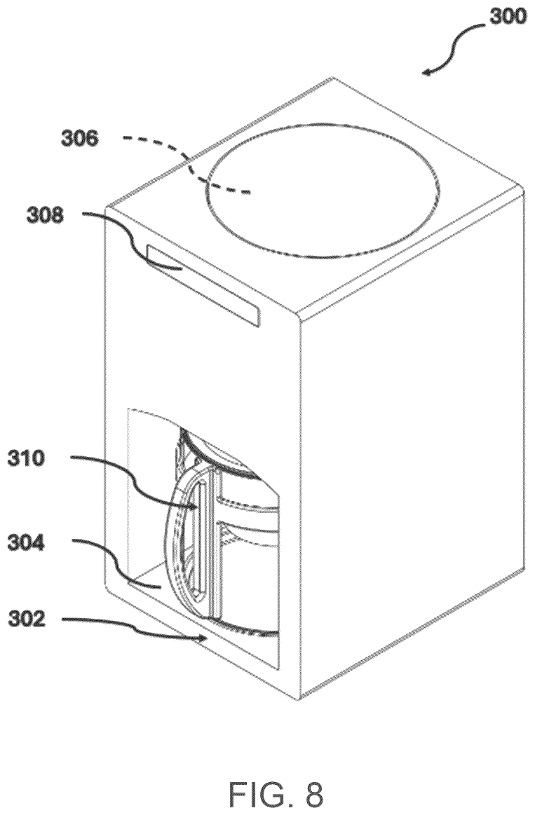

Turning to FIGS. 8 through 10, a third embodiment of a PEF coffee maker is shown, particularly, a flow-through brew PEF coffee maker 300. The PEF coffee maker 300 includes a source of a pulsed electric field (PEF).

In this embodiment, the unbrewed water and coffee grounds, brewing chamber (which includes the pulse source) and brewed water all have distinct volumes with flow from one into another. Internal to the base are various system components including a PEF cell, pulse generator unit, user interface unit and a control unit. In this coffee maker 300, the liquid flow between the distinct volumes may be due to gravity, mechanically pumped or pressure assisted.

Seen in FIG. 8, the flow-through brew PEF coffee maker 300 includes a base 302, a pot cubby 304, a user interface 308, and a supply 306 that provides both water and coffee grounds. The pot cubby 304 is shown with a removable glass container 310.

The water/grounds supply 306 may be wholly contained within the base 302 or may be operably coupled to a water supply source (not shown), such as a faucet or plumbed line, so that an appropriate amount of water is automatically supplied. If within the base 302, the water/grounds supply 306 has an internal reservoir where water is stored and from which the water is dispensed through the water/grounds dispensing port (not shown) at the lower side of the water/grounds supply 306.

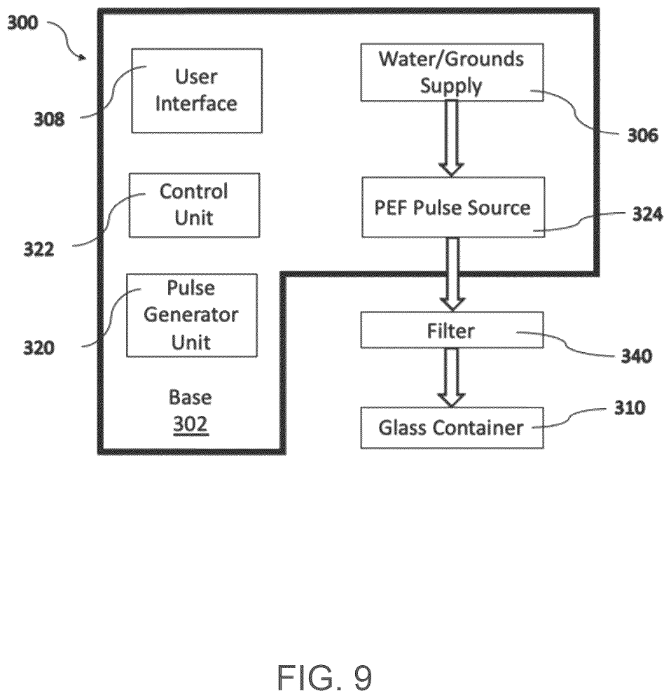

FIG. 9 shows the components of the flow-through brew PEF coffee maker 300 in a block diagram format. As part of the base 302 are the pulse generator unit 320, a control unit 322 for the generator unit 320, the supply 306, the user interface 308, and a PEF pulse source 324 with at least two electrodes. The components are appropriately connected so that flow from the water/grounds supply 306 passes through the pulse source 324, through a filter 340, and into the glass container 310.

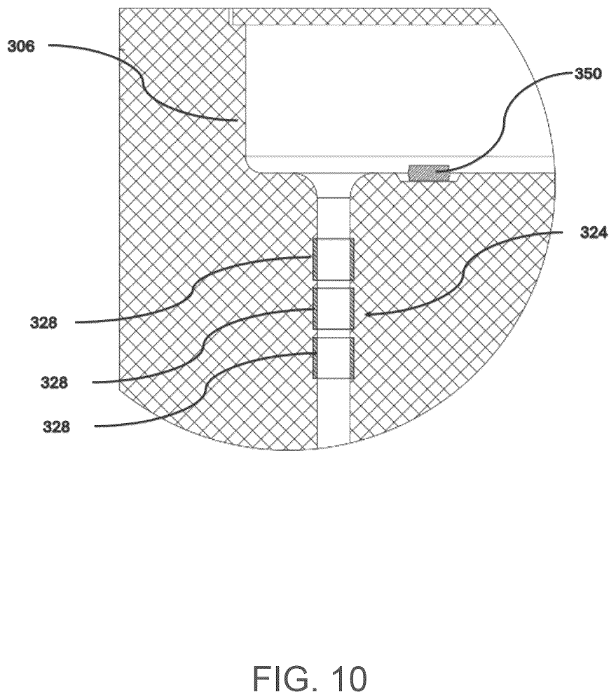

A portion of the base 302 of the coffee maker 300 is shown in cross-section in FIG. 10, where the water/grounds supply 306, an internal circulation pump 350, and the pulse source 324 with three electrodes 328 are seen. The electrodes 328 are axially aligned, so that the water/grounds mixture passes sequentially therethrough. Two of the electrodes 328 are either ground/negative (−) or positive (+), with the other electrode 328 being the other polarity.

In operation of the flow-through brew PEF coffee maker 300, a user places the container 310 in the pot cubby 304 and presses the start button (not shown) on the user interface 308.

The flow-through brew PEF coffee maker 300 can perform the same safety checks as the PEF coffee makers 100, 200.

The parameters for brewing with the flow-through brew PEF coffee maker 300 can be the same as those for the coffee makers 100, 200, however, because it is a flow-through coffee maker compared to a percolator, pot brew (immersion-type), or drip brew, the time for the exposure of the coffee grounds to the water and to the PEF pulse is less. For example, the flow-through coffee maker 300 has a PEF brewing time of at least 0.1 second, in other embodiments at least 0.5 second or at least 1 second. Typically, for a flow-through coffee maker, the brewing time is no more than 30 seconds, with a preferred PEF brew time between 1 second and 10 seconds.

During brewing, the liquid is exposed to a field strength from the pulse source 324 of at least 0.2 KV/cm, in some embodiments between 0.2 KV/cm and 5.0 KV/cm. A particular example field strength is between 0.8 KV/cm and 3.0 KV/cm.

Simultaneously, the liquid is exposed to an energy from the pulse source 324 of at least 5 J/ml. A better energy exposure is between 5 J/ml to 50 j/ml. A particular example energy exposure is between 10 J/ml to 24 j/ml.

Although any of the PEF coffee makers 100, 200, 300 shown herein can be scaled to any reasonable size and volume, the flow-through maker 300 is particularly adaptable for high volume commercial or industrial production.

Additionally, for each of the coffee makers 100, 200, 300 and variations thereof, the container 110, 210, 310 is not a required element, as it is possible to configure any of the coffee makers 100, 200, 300, particularly the flow-through brew PEF coffee maker 300, with a remote container to which brewed coffee can be dispensed from the PEF pulse source.

With each of the coffee makers 100, 200, 300 and variations thereof, for the purpose of reducing brewing time, increasing yield, and/or enhancing taste, PEF may be used in conjunction with other process including, but not limited to hot brewing, extraction, agitation, mixing, or vacuum extraction.

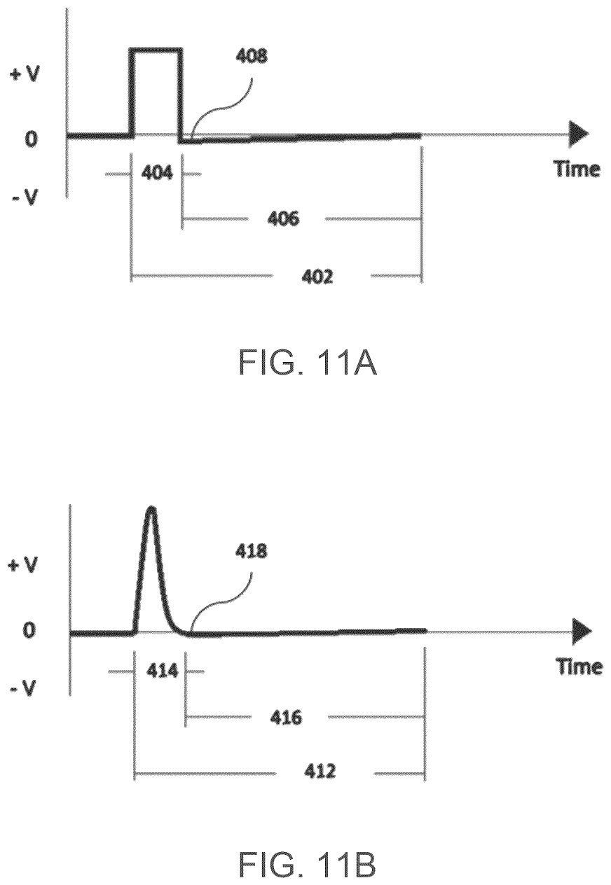

FIGS. 11A and 11B illustrate typical PEF pulse cycles, suitable for any of coffee makers 100, 200, 300 and variations thereof.

FIG. 11A shows a square waveform cycle 402 over time that includes a positive “on” phase 404 and a zero or negative “off” phase 406. The off phase 406 may have a negative portion 408 to reduce galvanic reaction.

FIG. 11B shows an exponential decay waveform cycle 412 over time that includes a positive “on” phase 414 and a zero or negative “off” phase 416. The off phase 416 may have a negative portion 418 to reduce galvanic reaction.

### EXAMPLES

The following non-limiting examples were performed to evaluate the effect of PEF on cold brewing processes; three coffee brewing processes were compared. Standard cold brew, cold brew (with circulation) and PEF cold brew (with circulation) were evaluated for electrical conductivity (μS/cm), clarity, and taste. A prototype pot brew PEF coffee maker, in accordance with the coffee maker 100 described above, was used for the evaluation.

Conductivity measures the ability of a liquid to pass an electrical current and reveals changes in the solubilization consistent with PEF. This includes the concentration of coffee's desired bioactive organic compounds (e.g. caffeine and antioxidants such as chlorogenic acids and hydroxycinnamic acids) since PEF creates additional pores that enhances surface and near surface solubilization.

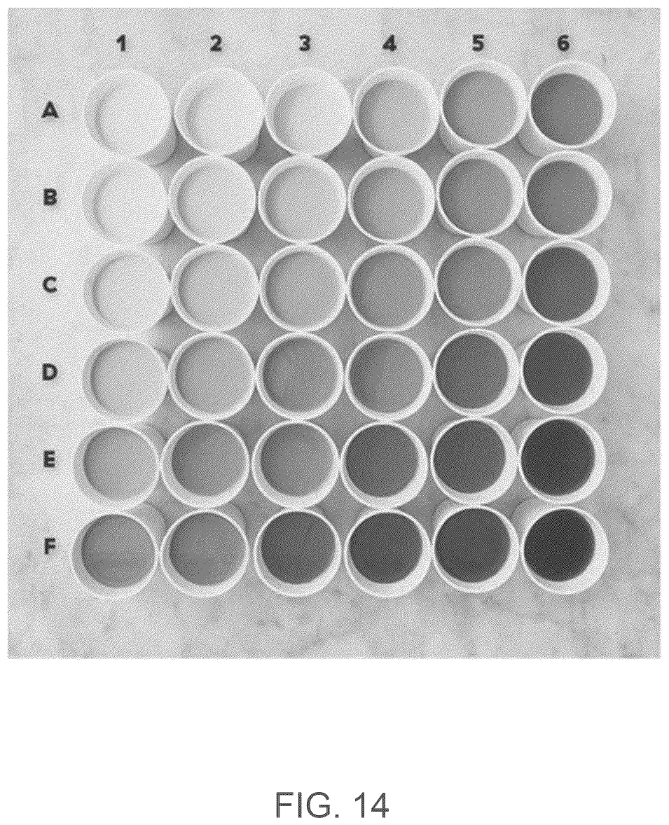

Clarity was visually compared using a color chart (FIG. 14).

The taste was based on the tester's opinion.

A non-blended coffee and deionized water were selected for consistency for the following examples. Other coffee beans, roast styles, and water may be used.

### Example 1

The objective of Example 1 was to compare standard cold brew, cold brew (with circulation), and PEF cold brew (with circulation) at a grounds:water ratio 1:42 (by wt.).

The roasted coffee beans used are shown in TABLE 1.

TABLE 1

| Bean | Roast | Grind |
|---|---|---|
| Arabica (Kirkland Colombian Supremo) | Medium Roast | Coarse Ground |

The generator properties are shown in TABLE 2, below.

TABLE 2

| | | Pulse | Energy- | | | Pulses |
|---|---|---|---|---|---|---|
| | Voltage | width | target | Water | Coffee | planned |
| Test | (V) | (msec) | (J/ml) | (g) | (g) | (#) |
| C | 3000 | 0.02 | 20 | 500 | 12 | 2328 |

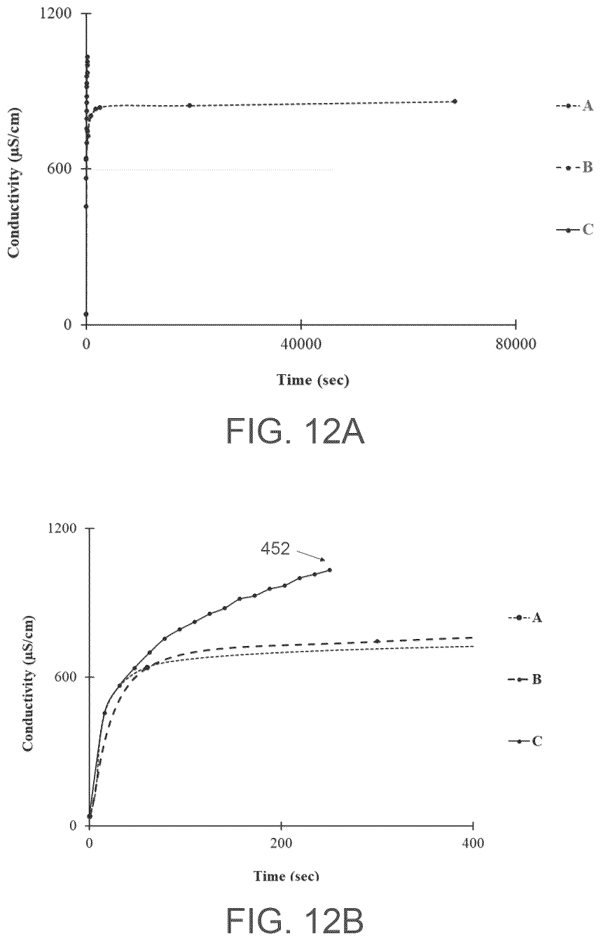

The results of the experiment from Example 1 are shown in TABLE 3, below, and in FIGS. 12A, 12 and 14.

FIG. 12A illustrates solution conductivity (microsections/cm) over the brew time for standard cold brew (line A), cold brew brewed with circulation (line B) and PEF cold brew brewed with circulation (line C), all at a grounds:water ratio of 1:42. FIG. 12B is an enlarged view of a portion of FIG. 12A.

These graphs of FIGS. 12A and 12B show the effect of adding PEF to cold brewing, both with and without circulation. The results show that PEF cold brewing, with circulation, had a significantly higher conductivity after a 360 second brew time compared to either non-PEF process.

During the PEF cold brew example (line C) in FIG. 12B, it is noted that the generator faulted at the point designated as 452 (at approximately 250 seconds), resulting in less energy being delivered than desired; this is further shown in TABLE 3 below. This fault was consistent with generator limits relative to the large electrode pulse source used (pulse source 134 of FIG. 4A of the coffee maker 100). It is believed that such generator faults can be avoided by increasing the generator current limits and/or using a small parallel electrode chamber (pulse source 144 of FIG. 4B) or small co-linear electrode chamber (pulse source 154 of FIG. 4D).

TABLE 3

| | Field | Pulses | Pulses | Energy | Energy | | Clarity | |
|---|---|---|---|---|---|---|---|---|
| | strength | planned | actual | target | actual | Conductivity | (chart) | Taste |
| Test | (V/cm) | (#) | (#) | (J/ml) | (J/ml) | (μS/cm) | FIG. 14 | (tester) |
| A | N/A | N/A | N/A | N/A | N/A | 859 | E5 | N/A |
| | | | | | | (at 68,850 secs) | | |
| B | N/A | N/A | N/A | N/A | N/A | 829 | E2~E3 | N/A |
| | | | | | | (at 1800 secs) | | |
| C | 2308 | 2328 | 1455 | 20 | 7.1 | 1032 | E4 | Pleasant |
| | | | | | | (at 250 secs) | | taste |

A: Standard Cold Brew
B: Cold Brew (with circulation)
C: PEF Cold Brew (with circulation)

### Example 2

The objective of Example 2 was to compare standard cold brew, cold brew (with circulation), and PEF cold brew (with circulation) at a grounds:water ratio 1:32 (by wt.).

The roasted coffee beans used are shown in TABLE 4.

TABLE 4

| Bean | Roast | Grind |
|---|---|---|
| Arabica (Kirkland Colombian Supremo) | Medium Roast | Coarse Ground |

The generator properties are shown in TABLE 5.

TABLE 5

| | | Pulse | Energy- | | | Pulses |
|---|---|---|---|---|---|---|
| | Voltage | width | target | Water | Coffee | planned |
| Test | (V) | (msec) | (J/ml) | (g) | (g) | (#) |
| B | 3000 | 0.01 | 10 | 500 | 16 | 2328 |

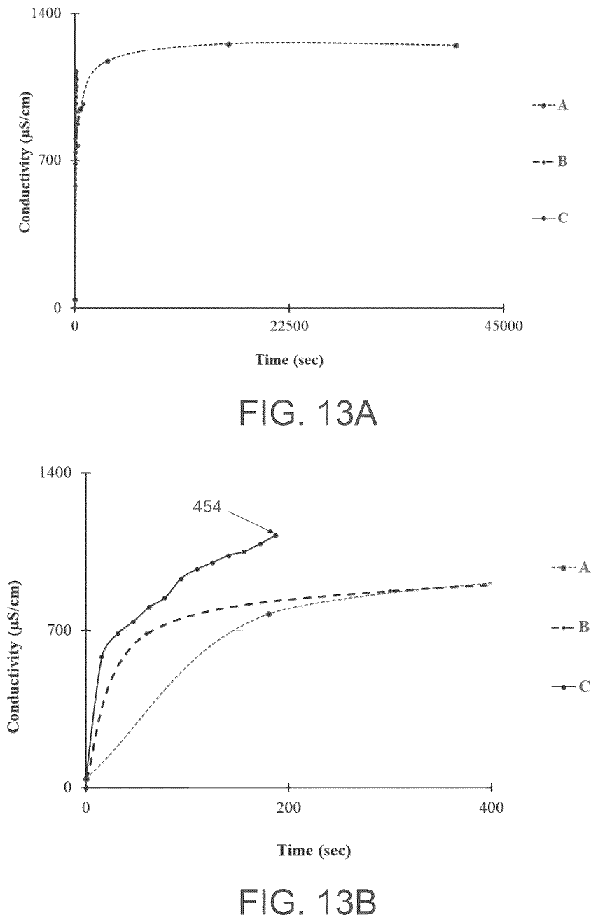

The results of the experiment from Example 2 are shown in TABLE 6, FIGS. 13A, 13B, and 14.

TABLE 6

| | Field | Pulses | Pulses | Energy | Energy | | Clarity | |
|---|---|---|---|---|---|---|---|---|
| | Strength | planned | actual | target | actual | Conductivity | (chart) | Taste |
| | (V/cm) | (#) | (#) | (J/ml) | (J/ml) | (μS/cm) | FIG. 14 | (tester) |
| A | N/A | N/A | N/A | N/A | N/A | 1248 | E5 | N/A |
| | | | | | | (at 39,960 secs) | | |
| B | N/A | N/A | N/A | N/A | N/A | 1041 | E2~E3 | N/A |
| | | | | | | (at 1800 secs) | | |
| C | 2308 | 2328 | 1164 | 10 | 3.3 | 1121 | not | Pleasant |
| | | | | | | (at 188 secs) | done | taste |

A: Standard Cold Brew
B: Cold Brew (with circulation)
C: PEF Cold Brew (with circulation)

FIG. 13A illustrates conductivity of standard cold brew (line A), cold brew brewed with circulation (line B) and PEF cold brew brewed with circulation (line C), all at a grounds:water ratio of 1:32. FIG. 13B is an enlarged view of a portion of FIG. 13A.

These graphs of FIGS. 13A and 13B show the effect of adding PEF to cold brewing, both with and without circulation, for a longer time period than the examples of the graphs of FIGS. 12A and 12B.

During the PEF cold brew example (line C) in FIG. 13B, it is noted that the generator faulted at the point designated as 454 (at approximately 188 seconds), resulting in less energy being delivered than desired; this is further shown in Table 6 above. These faults were consistent with generator limits relative to the large electrode pulse source used (pulse source 134 of FIG. 4A of the coffee maker 100). It is believed that such generator faults can be avoided by increasing the generator current limits and/or using a small parallel electrode chamber (pulse source 144 of FIG. 4B) or small co-linear electrode chamber (pulse source 154 of FIG. 4D).

From the foregoing description and examples, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Various features and details have been provided in the multiple designs described above. It is to be understood that any features or details of one design may be utilized for any other design, unless contrary to the construction or configuration. Any variations may be made.

The above specification and examples provide a complete description of the structure and use of exemplary implementations of the invention. The above description provides specific implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Spatially related terms, including but not limited to, “bottom,” “lower”, “top”, “upper”, “beneath”, “below”, “above”, “on top”, “on,” etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above or over those other elements.

What is claimed:

1. A PEF brewing system comprising:
a chamber for receiving a mixture of a liquid and a substance for extraction of flavor therefrom;
a liquid source fluidly connected to the chamber to provide the liquid to the chamber;
a pulse source comprising at least two electrodes, the pulse source in fluid and electrical contact with the mixture in the chamber to provide a field strength of at least 0.2 KV/cm to the mixture;
a liquid pump fluidly connected to the chamber; and
a container fluidly connected to the pulse source to receive the liquid from the pulse source.

2. The system of claim 1, wherein the liquid source is a liquid reservoir.

3. The system of claim 1, wherein the liquid source is a piped, on-demand liquid source.

4. The system of claim 1, wherein the pulse source is within the chamber.

5. The system of claim 1, wherein the pulse source is configured to provide a field strength of 0.2 KV/cm to 5 KV/cm to the mixture.

6. The system of claim 1, wherein the pulse source is configured to provide an energy of at least 5 J/ml to the mixture.

7. The system of claim 1 further comprising a filter fluidly connected to the chamber to receive and filter the liquid from the pulse source.

8. The system of claim 1, wherein the chamber, the liquid source, the pulse source, the liquid pump and the container are a single unit.

9. The system of claim 1 further comprising a base having the liquid source therein, and wherein the chamber and the pulse source are a single unit.

10. The system of claim 1 further comprising a base having the liquid source, the chamber and the pulse source therein.

11. The system of claim 1, wherein the pulse source comprises a first electrode having a first polarity and a second electrode and a third electrode having a second polarity opposite the first polarity.

12. A method of cold brewing a beverage, the method comprising:
providing a chamber retaining a substance for extraction of flavor therefrom;
adding a liquid to the substance in the chamber to form a mixture;
exposing the mixture in the chamber to a pulsed electric field at a field strength of at least 0.2 KV/cm;
filtering the exposed mixture to extract brewed liquid; and
collecting the brewed liquid in a container.

13. The method of claim 12, wherein adding a liquid to the substance in the chamber comprises providing the liquid from a reservoir.

14. The method of claim 12, wherein the beverage is one of coffee, tea, espresso, and infused water.

15. The method of claim 12, wherein the substance is coffee grounds.

16. The method of claim 12, wherein exposing the mixture in the chamber to a pulsed electric field comprises exposing the mixture to a field strength of 0.2 KV/cm to 5.0 KV/cm for at least 30 seconds.

17. The method of claim 12, wherein exposing the mixture in the chamber to a pulsed electric field comprises exposing the mixture for at least 30 seconds.
